(19) United States
(12) Patent Application Publication
(10) Pub. No.: US 2006/0255176 A1
(43) Pub. Date: Nov. 16, 2006

(54) Electric motor driven showerhead

(76) Inventor: John O. Yeiser, Alpine, CA (US)

Correspondence Address: PROCOPIO, CORY, HARGREAVES & SAVITCH LLP, 530 B STREET, SUITE 2100, SAN DIEGO, CA, 92101, US

(21) Appl. No.: 11/387,100

(22) Filed: Mar. 21, 2006

Related U.S. Application Data
(60) Provisional application No. 60/663,903, filed on Mar. 21, 2005.

(51) Int. Cl. B05B 3/00

(52) U.S. Cl. 239/263.1; 239/99; 239/101; 239/550; 239/225.1

(57) ABSTRACT

The pulsating spinning showerhead includes a water inlet, water channels for distributing water from the water inlet, and spray nozzles for receiving water from the water channels and projecting a water stream out of the showerhead. At least one valve controls water flow to the spray nozzles. One or more micromotors provides alternating activation of valve so that the spray nozzles receive water in cycles to produce a pulsating output of water. The micromotor and valve are powered by a low voltage power source. In the preferred embodiment, the power source is one or more batteries.

### RELATED APPLICATIONS

This application claims the priority of provisional application Ser. No. 60/633,903, filed Mar. 21, 2005, which is incorporated herein by reference in its entirety.

### BACKGROUND OF THE INVENTION

The current technology for massaging showerheads uses internal valves in the showerhead operated via water pressure. One design involves the use of a turbine wheel inside the showerhead which will spin when water is directed into it. The turbine is connected to or has small holes in it that cause it to act like a rotary valve that opens and closes a water passage as it spins around. The resulting water output is a pulsating stream of water, which produces a massaging action. A variation of the turbine involves connecting individual nozzles to a turbine wheel or an eccentric shape which, when water comes in contact with it, either wiggle or spin. This motion is transferred to the water tip, causing them to wiggle, thus providing a water stream that oscillates in one plane. The resulting water stream appears to be rotating or moving, providing a massaging effect to the user. The problem with these and other similar designs is that the use of water pressure or flow as the means for energy to actuate a valve or rotate a water nozzle causes the effectiveness to be dependent on water pressure. To increase the strength of the massage, the user would need to increase the pressure of water and or flow, which has the downside that high water pressure comes into contact with the user's skin, which can be uncomfortable. In addition, the valve mechanism or rotating mechanism spins faster so that the time between pulses decreases, which reduces the initial desired effect of pulsating water. If the time between pulses is reduced too much, the user effectively loses the pulsating sensation, instead sensing a regular or disturbed water flow. On the other hand, if the user wants to reduce the speed of the massager, it can only be accomplished by reducing the flow and or pressure to the driving mechanism. This reduces the rotational speed and increases the time between pulses, however, the water pressure may be reduced below an effective threshold for producing a massaging sensation. In addition, if the user has low water pressure, the overall desired effect of any water driven mechanism is reduced significantly to the point that it may not work at all.

Accordingly, the need remains for an alternate drive mechanism for use in a showerhead for providing controllability of multiple components of the massaging action. The present invention is directed to such a showerhead.

### BRIEF SUMMARY OF THE INVENTION

The aforementioned problems are solved and improvements to the massaging effect are provided by the use of miniature battery-powered electric motors or solenoids to actuate valving, rotate nozzles, or actuate nozzles in various axes or planes of motion. Because such electric solenoids and motors are very small and operate with low power consumption, the inventive showerhead can be compact while possessing long battery life. Optionally, the device can be hardwired if desired, using a very low voltage, DC current from a converter plugged into an electrical outlet located at a safe distance from the shower stall. Among the advantages of the inventive showerhead design are that the water pressure is irrelevant to the actuation or energy required to provide the massaging action. This addresses a problem in some areas that have low water pressure, which in the past had been prevented from using massaging showerheads. In addition, the pulsing of the water can be virtually infinitely adjusted to produce the precise massaging effect desired by the user. Where a rotational mechanism is used, the rotational speed of the nozzle or showerhead can be adjusted to the desired speed regardless of water pressure or flow. In an alternate embodiment, an energy storage bladder or piston can be disposed between the water source and the valve body so that a slight pressure build-up occurs during the periods when the valve mechanism is closed. When the valve re-opens the initial release of water will have increased pressure for a more desirable massaging effect. This feature is particularly advantageous in areas that have low water pressure.

In an exemplary embodiment, the pulsating spinning showerhead comprises a water inlet; a plurality of water channels for distributing water from the water inlet; a plurality of spray nozzles for receiving water from the plurality of water channels, each spray nozzle for projecting a water stream out of the showerhead; at least one valve for controlling water flow to the plurality of spray nozzles; at least one micro-motor for alternating activation of the at least one valve so that the plurality of spray nozzles receive water in cycles to produce a pulsating output of water; and at least one low voltage power source for providing power to operate the at least one micro-motor. In the preferred embodiment, the power source is one or more batteries.

### BRIEF DESCRIPTION OF THE DRAWINGS

FIG. 1 is a diagrammatic view of a first embodiment of a showerhead according to the present invention;

FIG. 2 is a diagrammatic view of an exemplary multi-solenoid valve arrangement within the inventive showerhead in which each solenoid is connected to a microcontroller;

FIG. 3 is a diagrammatic view of an alternative rotary valve embodiment;

FIG. 4 is a diagrammatic view of an alternative embodiment of the present invention incorporating a micro-controller for controller a solenoid valve;

FIG. 5 is a diagrammatic view of an alternative embodiment having multiple valves in which each valve is driven by a single electric motor;

FIG. 6 is a diagrammatic view of an alternative embodiment having gear driven valves and a spray nozzle for directing the spray pattern in a circle;

FIG. 7a, b and c are diagrammatic views of alternative configurations for increasing pulse pressure from a spray nozzle;

FIG. 8 is a diagrammatic view of an alternative embodiment of the showerhead having an eccentric cam mechanism for producing a wiggle spray;

FIG. 9 is a cross-sectional view of the embodiment of FIG. 1;

FIG. 10 is a perspective view of the nozzle assembly of the showerhead;

FIG. 11 is perspective view of a showerhead in a housing.

### DETAILED DESCRIPTION OF THE PREFERRED EMBODIMENTS

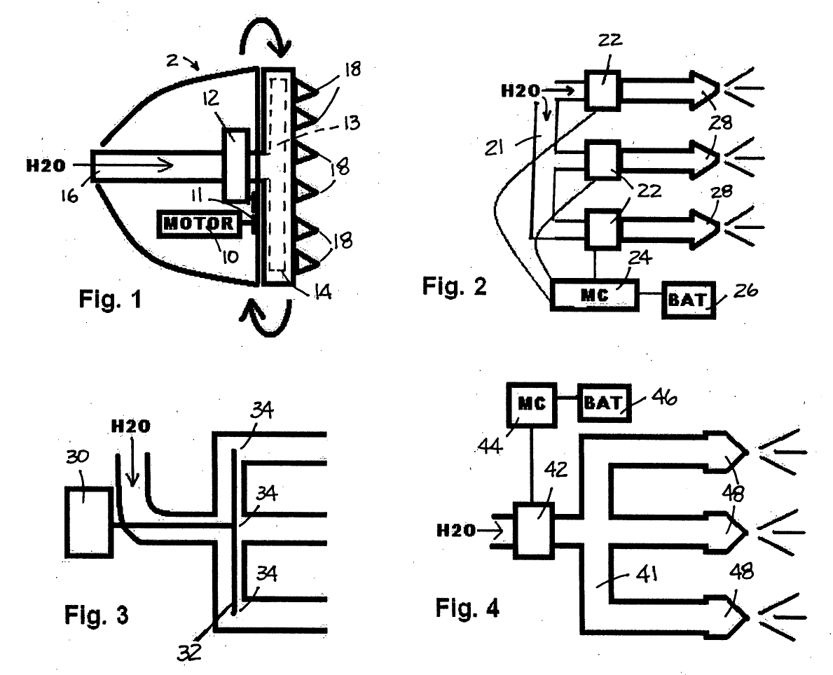

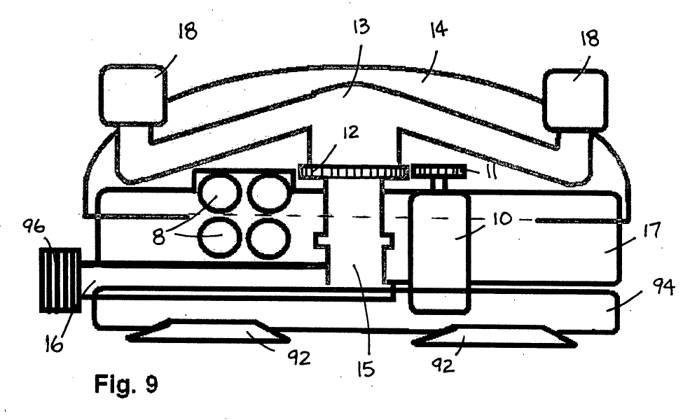

As illustrated in FIG. 1, a first embodiment of the inventive showerhead 2 utilizes a mini- or micro-electric motor 10 to drive, either directly or through a gear reduction, by gear 12, the face plate 14 of the showerhead causing it to rotate. As illustrated drive gear assembly 11 transfers rotational force from motor 10 to gear 12. Water is introduced through water inlet 16 and into an interior cavity or manifold 13 within face plate 14. A plurality of nozzles 18 is disposed in or on the outer surface of face plate 14 to release streams of water that rotate as manifold 13 and plate 14 rotate, producing a massaging action. In the more detailed illustration in FIG. 9, water entering through inlet 16 is directed into manifold 13 which distributes the water to nozzles 18. The manifold 13 and nozzles 18 rotate with along with face plate 14, as does the axial tube 15. Axial tube 15 is connected to inlet 16 by way of a rotating joint that permits water to flow continuously while axial tube 15 rotates relative to inlet 16.

Miniature and micro-motors are commercially available and are widely used in toys, consumer electronics and vehicles, among other applications. Preferably, the motor is a DC electric motor connected to one or more small, e.g., A or AAA batteries 8, or multiple Ni-Cad batteries or other small camera or calculator batteries capable of generating sufficient voltage to drive the motor. Motor 10 and batteries 8 are retained within a separate, waterproof chamber 17. A button (not shown) or other appropriate switch on the side of the showerhead is electrically connected to the motor 10 so that, when activated, the face 14 of the showerhead rotates. Preferably, the button will be protected under a flexible, water-resistant cover to prevent water intrusion into the conductors of the circuitry. A speed control device may be connected, either in combination with the button, e.g., a knob or toggle switch with multiple settings, or a separate knob or switch in line with the button, to allow the user to adjust the rotations per minute to his or her own preference. The speed control device may be simply a rheostat or other voltage level controller, but is preferably a programmable microcontroller with appropriate interface microcircuitry that provides control signals to the motor. The microcontroller can be used in conjunction with different combinations of electric solenoids and motors to provide programmable variability of operation for different timing of the opening and closing of valves, rotational speed, delays and pauses, among others. Optionally, an LCD or LED display screen can be connected to the microcontroller to provide a display of selections made during programming.

This same rotating gear concept can be applied for individually rotating each spray nozzle within a showerhead. The independent operations allows the creation of various patterns rotating in a different combinations. In this embodiment, a gear assembly is provided in which a single motor drives the gears for each nozzle. If desired, the gear ratios can be selected to drive each nozzle at a different rotational speed. Alternatively, a separate motor may be used for each nozzle, allowing the nozzles to be rotated separately and with different speeds or patterns.

In an alternate embodiment, actuation of the nozzles and or the outer portion of the showerhead can be moved using linear actuators with either electric solenoids or electric motors and the corresponding gear sets to cause the individual spray nozzles to move back and forth and or cause the outer portion of the showerhead to move back and forth, pivoting from a central axis point and or rotating back and forth.

As illustrated in FIG. 2, solenoid valves 22 are alternately activated to release water from manifold 21 through corresponding nozzles to create a pulsing effect. Activation of the solenoid valves 22 is controlled by microcontroller 24 which is programmable to provide any number of pulsing patterns that may be selected by the user. The solenoids 22 and microcontroller 24 are powered by battery 26. In an alternate configuration, a single solenoid valve 42 is activated to release pulsed water into manifold 41 and out through nozzles 48. Microcontroller 44 is programmable to control activation of solenoid valve 42 to produce a variety of different pulsing actions in the water released through nozzles. Again, the solenoid 42 and microcontroller are powered by battery 26.

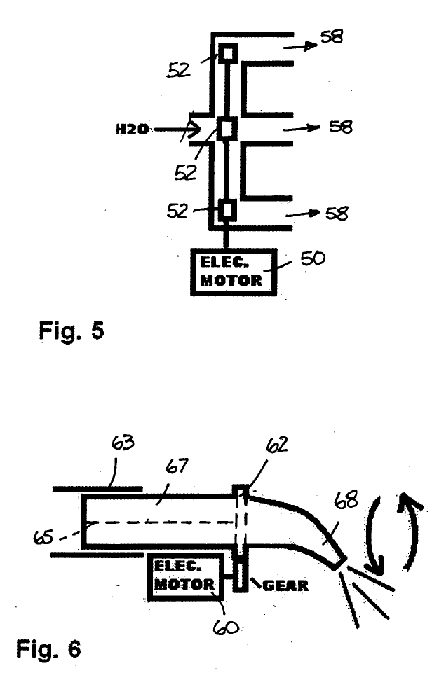

In another embodiment, an electric motor can be used to actuate valving that can cause a pulsing effect of the water. As illustrated in FIG. 3, an electric motor 30 can be used to spin a rotary valve 32 to alternately open water ports 34, causing pulsed water to be emitted from the showerhead. FIG. 5 provides an alternate configuration to the embodiment of FIG. 3, where motor 50 controls a separate valve 52 corresponding to each nozzle, allowing the output water streams to be alternated in various patterns to create the desired massaging effect.

In the preferred version the electric motor and or valves are located within the showerheads traditional enclosure. In another embodiment the electrical components can be mounted in a casing to the exterior of a traditional showerhead enclosure, this can offer benefits to space issues and provide room for additional motors, batteries, or microcontrollers.

FIG. 6 illustrates an embodiment with an asymmetric nozzle 68 that can create a circular spray pattern when the nozzle is rotated. Motor 60 drives gear 62, which is disposed around the nozzle inlet side 67. Nozzle inlet side 67 is retained within a swivel joint 63 allowing the nozzle inlet side 67 to rotate around its central axis 65. The asymmetric nozzle 68 traces a circular pattern. Multiple such nozzle assemblies can be disposed within a single showerhead that can optionally include another motor for separately rotating the face plate. In addition, valves may be included upstream of each nozzle inlet 67 to provide pulsing action to the water. The showerhead can incorporate a combination of the same or different nozzle assemblies in which some of the nozzles rotate, wobble, move linearly, while others remain stationary. The various combinations can be applied to achieve the most desirable sensation to the user.

Optionally, an LED can be incorporated into the showerhead to provide visual effects for stimulation or relaxation as the showerhead is spinning, moving, or oscillating. This light may also be used to provide subdued lighting to illuminate the interior of the shower stall.

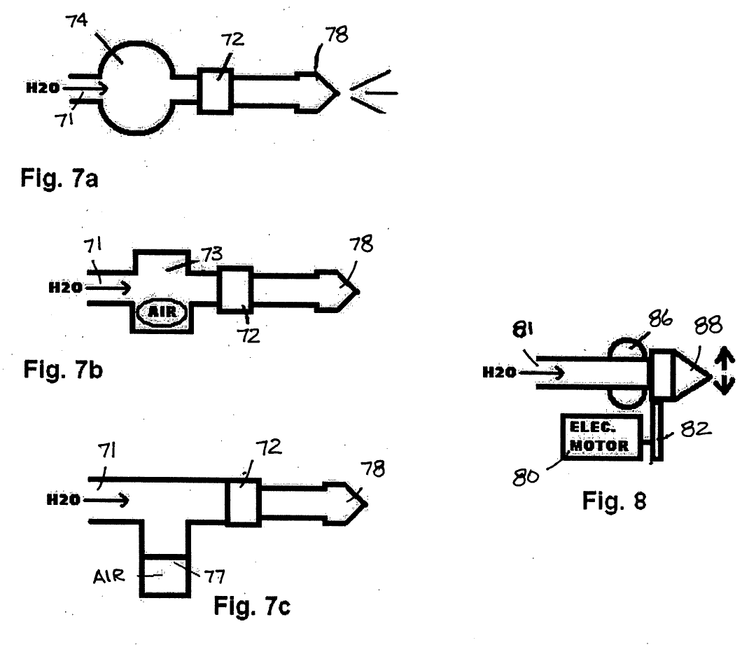

Another advantage of being able to control the pulsations of water independently of the water pressure and/or flow is that an energy/water storage device can be incorporated upstream of the valve for each spray nozzle outlet to produces a capacitive effect of briefly storing the water until the volume is full and the valve is opened downstream. In one embodiment, an expandable volume is provided by way of a flexible bladder, as shown in FIG. 7a. When the valve 72 is closed, water continues to enter inlet 71, filling the flexible bladder 74. Bladder 74 expands and builds pressure so that when the valve 72 is opened, the stored water is released from nozzle 78 as a pulse at a greater pressure than would be available under a continuous flow operation. FIG. 7b illustrates an second possible configuration using an expandable air bladder 75 to fill the storage volume 73. Storage volume 73 is filled when valve 72 closes, compressing air bladder 75. When the downstream valve 72 is opened to release water through the nozzle 78, air bladder 75 expands to provide additional pressure. In the embodiment of FIG. 7c, a temporary blockage is created using a piston 77 that blocks the water stream under the valve 72 is released. In each of the embodiments of FIGS. 7a-c, as a microcontroller or motor causes the valves to open and close to control the water flow, the back pressure surge of water with the valve closed causes a momentary spike in water pressure causing this increase in energy to be stored in the rubber material, air bladder or air in the piston cylinder combination. As the valve opens again, the energy is released producing a sudden increase in water pressure to momentarily amplify the pulsing sensation detected by the user.

FIG. 8 illustrates an embodiment that can be used to generate an oscillating or wiggle spray by moving the nozzle tip 88 within the plane of the face plate. Micromotor 80, through an eccentric cam 82, or gears, gear reduction or linear actuator, causes the nozzle 88 to move up and down (or side to side), i.e., perpendicular to the direction of water flow 81. Preferably, this nozzle assembly will be incorporated in showerhead with a rotating face plate so that the spray streams rotate as well as oscillate or wiggle.

In an exemplary embodiment, the showerhead is retained on the wall of the shower stall by at least one suction cup. As illustrated in FIG. 9, two suction cups 92 are shown attached to the outer back surface of a housing 94. The water supply is introduced into the showerhead by way of water inlet 96, which is a knurled or ribbed fitting that produces a water-tight fits within the end of a flexible tubing of appropriate diameter. Alternate connection means will be readily apparent to those in the art, including hard plumbing, screw-on attachments, and combinations thereof.

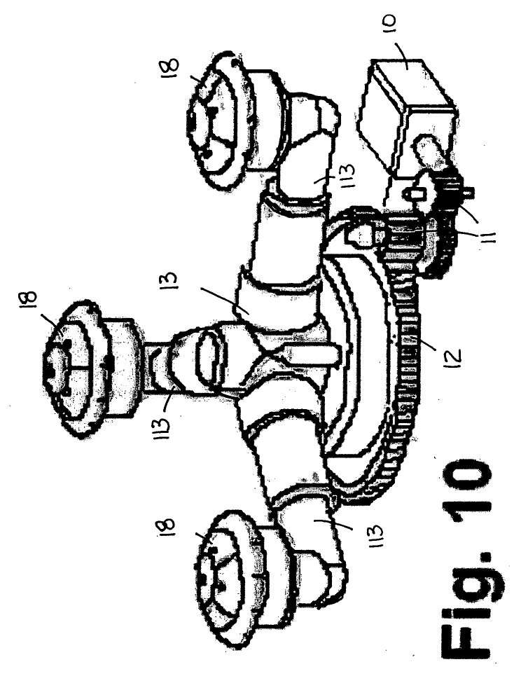

FIG. 10 illustrates a manifold and nozzle assembly that is rotated by a motor, according to the embodiments of FIGS. 1 and 9. As described previously, motor 10 drives gear assembly 11 which transfers force to gear 12. Gear 12 is attached to the bottom of manifold 13 which includes arms 113 that terminate with nozzles 18. Each nozzle 18 has a plurality of openings through which streams of water are emitted. In the preferred embodiment, the nozzle faces can be tilted by axially rotating arm 113 where it is inserted into manifold 13, which provides for variation in the direction of the water streams.

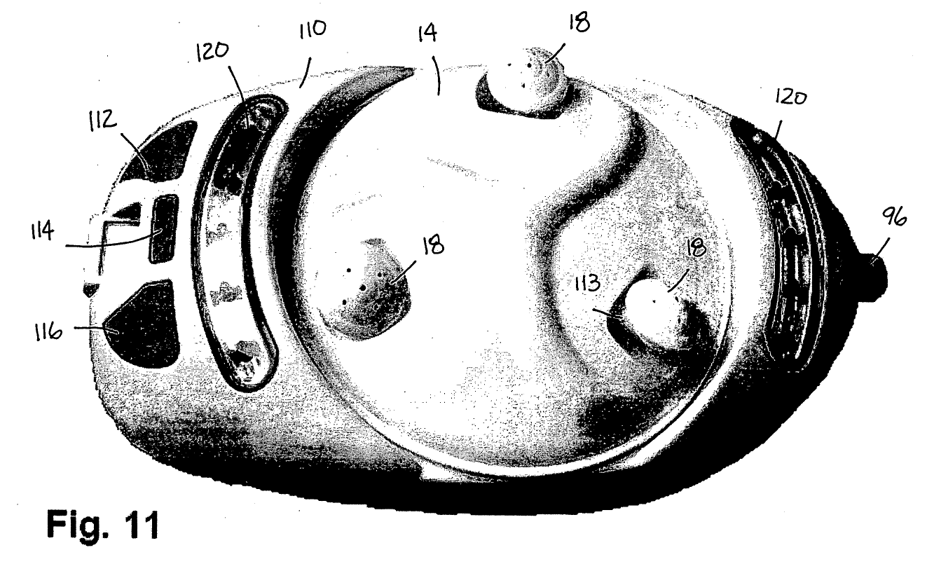

FIG. 11 illustrates an exemplary production showerhead that incorporates the present invention. The assembly of FIG. 10 is mounted within a housing 110. The arms 113 extend through openings through face plate 14 and the nozzles 18 are attached to the ends of arms 113 by a threaded attachment. The arms are inserted into manifold 13 in a way that allows each arm, and thus, the nozzle, to be rotated around its axis. This adjustment can be selected by the user to produce a wider or narrower spray pattern. Motor 10 (shown in FIG. 10) drives the rotation of face plate 14 and nozzles 18. The showerhead is activated by depressing one or more buttons 112, 114 and/or 116 which turn the motor on and off and control the rotational speed of the nozzles and/or the pulse rate of a valve controlling the water stream. The motor is preferably controlled by a microcontroller that has a number of program variations for selecting different spray patterns and pulse variations. The microcontroller may also provide signals for activating an LED display. One of the buttons 112, 114 and/or 116, or a separate button, may be used to turn the LED arrays 120 on or off, or to select variations in the light produced by the LEDs. The LED arrays may be used to provide illumination or as indicators of the operational settings selected on the showerhead.

The spinning and pulsating mechanisms described herein may be incorporated in various combinations into either overhead showerheads or body showers mounted on a vertical wall and directed toward the bathing area.

In the foregoing specification, the invention has been described with reference to specific exemplary embodiments thereof. It will, however, be evident that various modifications and changes may be made thereunto without departing from the broader spirit and scope of the invention as set forth in the appended claims and their full scope of equivalents.

1. A massaging showerhead comprising:
a water inlet;
a plurality of water channels for distributing water from the water inlet;
a plurality of spray nozzles for receiving water from the plurality of water channels, each spray nozzle for projecting a water stream out of the showerhead;
at least one valve for controlling water flow to the plurality of spray nozzles;
at least one micromotor for alternating activation of the at least one valve so that the plurality of spray nozzles receive water in cycles to produce a pulsating output of water; and
a power source for operating the at least one micromotor.

2. The massaging showerhead of claim 1, further comprising a rotating face plate connected to the at least one motor by a drive gear assembly, wherein the spray nozzles extend through and rotate with the face plate.

3. The massaging showerhead of claim 1, further comprising a manifold for distributing water from the inlet to the plurality of water channels, wherein the at least one valve is disposed downstream of a manifold.

4. The massaging showerhead of claim 1, further comprising a manifold for distributing water from the inlet to the plurality of water channels, wherein the at least one valve comprises a plurality of valve with one valve corresponding to each water channel.

5. The massaging showerhead of claim 1, further comprising a microcontroller for controlling activation of the micromotor, wherein the microcontroller is programmed to provide a plurality of user selectable spray patterns and pulse variations.

6. The massaging showerhead of claim 5, further comprising a plurality of light emitting diodes for providing a display indicative of a user selection.

7. The massaging showerhead of claim 1, wherein the power source is a battery.

8. The massaging showerhead of claim 1, wherein the power source is a low voltage converter.

9. The massaging showerhead of claim 1, wherein the water inlet is connected to a water source by flexible tubing.

10. The massaging showerhead of claim 1, further comprising a housing for retaining each of the water inlet, the water channels, the spray nozzles, the at least one valve, the micromotor and the power source.

11. The massaging showerhead of claim 10, further comprising at least one suction cup for releasably attaching the showerhead to a shower stall.
